(19) United States
(12) Patent Application Publication
(10) Pub. No.: US 2026/0167254 A1
(43) Pub. Date: Jun. 18, 2026

(54) Steering Column with a Lock

(71) Applicant: Robert Bosch GmbH, Stuttgart (DE)

(72) Inventors: Eddy Dupont, Cloyes les trois rivieres (FR); Laurent Fevre, Saint Sulpice de (FR)

(21) Appl. No.: 19/127,116

(22) PCT Filed: Nov. 3, 2023
(86) PCT No.: PCT/EP2023/080664

§ 371 Date: May 4, 2025

(30) Foreign Application Priority Data
Nov. 7, 2022 (FR) FR2211573

(51) Int. Cl. B62D 1/19; B62D 1/16; B62D 1/181; B62D 1/184; B62D 1/185; B62D 1/187; B62D 1/189

(52) U.S. Cl. CPC B62D 1/19; B62D 1/16; B62D 1/181; B62D 1/184; B62D 1/185; B62D 1/187; B62D 1/189; B62D 1/195

(57) ABSTRACT

A steering column having a base support and a steering member is disclosed. The steering column includes (i) a movable support which is mounted pivotably with respect to the base support, (ii) a lower tube which is mounted slidingly in the movable support, and (iii) an upper tube which is mounted slidingly in the sliding body. The movable support has a bolt with a locked state in which the bolt holds the sliding body axially in an extended position, and an unlocked state in which the bolt releases the sliding body. The base support has a control surface which is provided to bring about the unlocking of the bolt when the movable support is pivoted into its upper retracted position.

### TECHNOLOGY FIELD

The present invention relates to a vehicle steering column, in particular intended for use in a motor vehicle adapted to be operated in a manual driving mode or assisted driving mode and a delegated driving or autonomous driving mode.

### TECHNICAL BACKGROUND

In a vehicle, the steering column transmits the rotation of the steering wheel to the wheels to change their alignment, for example in the following order: Steering wheel, steering column, intermediate axis, gear rack, and finally the wheels.

Some motor vehicles may be equipped with a driver assistance system that allows the driver to delegate steering of the vehicle to a central control unit, at least temporarily. This is then a delegated driving mode or an autonomous or automatic driving mode.

During autonomous driving phases, such vehicles are in a state in which the steering wheel is unnecessary and cumbersome. There are systems that can be used to prevent the steering wheel rotation associated with wheel rotation and allow additional adjustment travel in depth and height to push the steering wheel into a retracted position that is more comfortable for the driver. Such a depth adjustment system may have a two-stage telescopic system with which a stroke of more than 100 mm and up to 250 mm can be realized. A first stage can be realized with a system comprising an upper tube and a sliding body or a lower tube and friction bearings that generate a force of the order of 500 N and make it possible to realize a stroke for comfort adjustment of the order of more or less 30 mm with respect to a so-called nominal middle position. A second guide system with balls between the sliding body and a pivoting body or movable support connected to the structure and generating a rolling force of the order of 250 N can realize the additional stroke of 70 to 200 mm required to retract the steering column.

A gear motor with a screw-nut system enables the movement of the steering wheel for both comfort adjustment and retraction of the steering column. The gear motor attached to the movable body actuates a nut connected to the screw and to the upper tube.

For safety reasons, the steering wheel adjustment system must know exactly which position the steering wheel is in and which of the two stages of the telescopic system is in motion. Since the force required to move each of the stages of the telescopic system is different, it is difficult to predict the position of each stage after multiple maneuvers. In particular after a change to the retracted position and subsequently return to the driving position, the steering wheel returns to the stored position, but the relative position of the two stages is different.

### BRIEF DESCRIPTION OF THE INVENTION

In particular, the invention aims to overcome the aforementioned disadvantages by proposing a solution that allows better control of the movement of each of the two stages of the telescopic system during maneuvers in which the steering wheel is brought into the retracted position and the driving position.

The invention proposes a steering column comprising a base support, which is intended to be fixedly mounted with respect to a vehicle chassis, and comprising a steering member, which is intended to be connected to a steering wheel, wherein the steering column is adapted to equip a vehicle that can be operated in a manual mode, in which steering is controlled by a driver using the steering member, and in an autonomous driving mode, in which the steering is controlled by an electronic control unit, wherein the steering member extends along a longitudinal main axis and comprises:
a movable support which is mounted pivotably with respect to the base support about a transverse main pivot axis between a lower position and an upper retracted position adapted to the autonomous driving mode,
a sliding body which is mounted slidingly in the movable support between an extended axial position adapted to allow steering control by a driver in the manual mode and a retracted axial position adapted to the autonomous driving mode,
an upper tube which is mounted slidingly in the sliding body between a front axial position and a rear axial position to allow a depth adjustment of the position of the steering member in the manual mode,
wherein the steering column further comprises actuators adapted to control the movement of the various components of the steering member between their different positions,
characterized in that the movable support comprises a bolt with a locked state, in which the bolt holds the sliding body axially in an extended position, and an unlocked state, in which said bolt releases the sliding body, and
the base support has a control surface which is provided to bring about the unlocking of the bolt when the movable support is pivoted into its upper retracted position.

According to further features of the invention:
the bolt comprises a lever which is mounted pivotably on the movable support about a transverse secondary pivot axis, wherein the lever comprises a locking arm which is provided to hold the sliding body in an extended position, and an actuating arm which is provided to rest against the control surface in the locked position;
the lever is mounted to a wall of the base support having a window, wherein the locking arm extends through the window;
the bolt has an elastic return element that biases the lever toward its locked position;
the lever comprises a locking arm provided with a blocking surface adapted to cooperate with a holding surface arranged oppositely on the sliding body when the bolt is in the locked state in order to hold the sliding body in an extended position;
the sliding body has a notch in which the holding surface is formed;
the steering member is provided with an additional unlocking device, which is provided to control the unlocking of the bolt when the upper tube exceeds an axial intermediate position between the front axial position and the rear axial position during an axial forward movement towards the upper tube due to a frontal impact;
the additional unlocking device comprises an unlocking finger arranged in the sliding body and is provided to cooperate with an unlocking ramp arranged on the upper tube;
the unlocking finger is arranged in a receptacle located in the notch.

### BRIEF DESCRIPTION OF THE DRAWINGS

Further features and advantages of the invention will be apparent upon reading the detailed description below; please refer to the accompanying drawings for assistance in understanding the description. The figures show:

FIG. 1 a schematic diagram depicting a vehicle equipped with a steering column having an adjustable and retractable steering member;

FIG. 2 a side view schematically depicting the steering column of FIG. 1, wherein the steering member is in an extended state;

FIG. 3 a perspective view depicting the steering column of FIG. 2, wherein the steering member is in the extended state;

FIG. 4 a partial perspective view depicting an upper part of the steering column of FIG. 2 equipped with a bolt;

FIG. 5 a partial view of a longitudinal section in the V-V plane showing the steering column of FIG. 2, wherein the steering member is extended and the bolt in its locked state blocks a sliding body of the steering member;

FIG. 6 a view similar to that of FIG. 5, which shows the steering member, wherein the bolt is in an unlocked state directly before retraction;

FIG. 7 a view similar to that of FIG. 5 showing the steering member in a forward-retracted state;

FIG. 8 a view similar to that of FIG. 5, showing the steering member in a transition state during a frontal impact causing the upper tube of the steering member to slide forward and begin unlocking the bolt;

FIG. 9 a view similar to that of FIG. 5, showing the steering member in a transition state following the state shown in FIG. 8 when the bolt is fully unlocked so that the sliding body of the steering member can slide forward to be retracted;

FIG. 10 a view similar to that of FIG. 5, showing the steering member in a transition state following the state illustrated in FIG. 9, in which the sliding body is partially retracted forward due to the front impact.

### DETAILED DESCRIPTION OF THE INVENTION

In the following description, identical, similar or analogous elements are marked with the same reference characters.

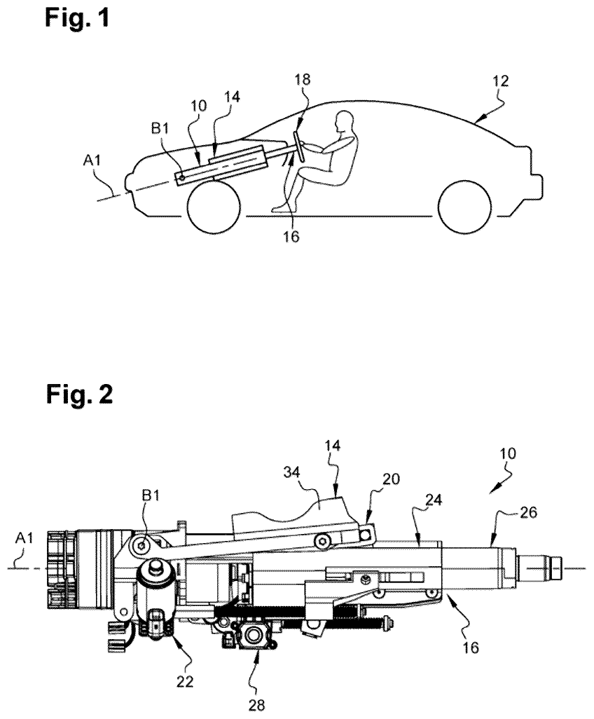

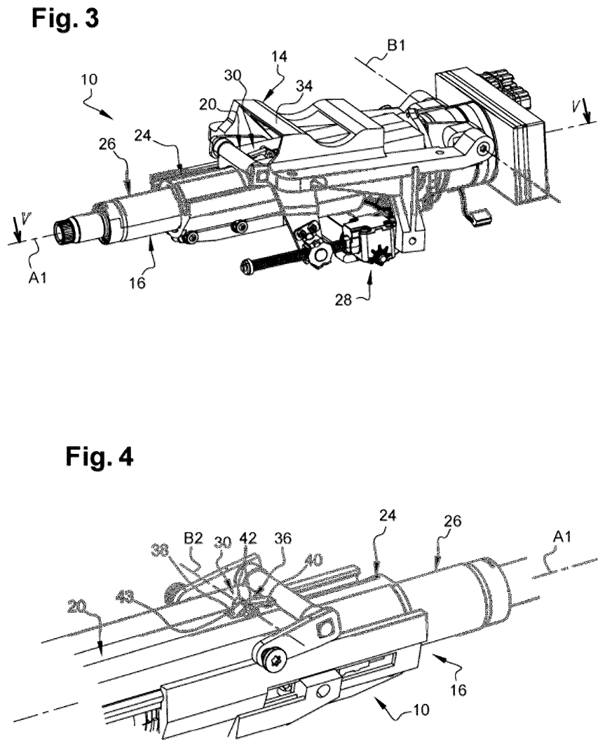

FIG. 1 shows a steering column 10 installed in a motor vehicle 12. The steering column 10, shown in more detail in FIGS. 2 and 3, comprises a base support 14, also referred to as a cap, that is designed to be fixedly mounted relative to a chassis of the vehicle 12. The steering column 10 comprises a steering member 16 to which a steering wheel 18 is mounted, which rotates about a longitudinally extending main axis A1.

The steering column 10 is also pivotable about a transverse axis B1 to allow for adjustment of its inclination, which also corresponds to a height adjustment for the steering wheel 18.

In the further description, an orientation from front to back along the longitudinal axis A1 is used in a non-limiting manner, which corresponds to an orientation from left to right when viewed in FIGS. 1 and 2.

The steering member 16 comprises a movable support 20 which is mounted pivotably with respect to the base support 14 about the transverse pivot axis B1 between a lower position shown in FIGS. 2-5 and 8-10, and an upper position shown in FIGS. 6 and 7. A swing actuator 28 allows the pivoting of the movable support 20 to be controlled, thereby driving the entire steering member 16.

The steering member 16 comprises a sliding body 24 carried by the movable support 20 and mounted slidingly in the longitudinal direction with respect to the movable support 20 between an extended axial position Pd, adapted to allow steering control by a driver in manual mode, and a retracted axial position PE, adapted to the autonomous driving mode.

It should be noted that the sliding body 24 can also have a shape that differs from the tube shown in the figures. It primarily represents a slidably movable body that allows the steering member 16 to retract.

The steering member 16 has an upper tube 26 which is mounted slidingly in the sliding body 24 between a front axial position P1 shown in FIG. 7, and a rear axial position P2 shown in FIGS. 2-6.

A sliding actuator 22, for example a gear motor, allows for control of the sliding movement of the sliding body 24 and the upper tube 26 with respect to the base support 14.

It should be noted that the steering column 10 is designed to assume a driving position when the vehicle 12 is in manual mode and a retracted position when the vehicle 12 is in autonomous driving mode.

Advantageously, the movable support 20 has a bolt 30 which has a locked position in which it holds the sliding body 24 axially in an extended position Pd and an unlocked position in which it releases the sliding body 24 so that it can slide forward into its retracted position Pe.

The base support 14 has a control surface 32 which is provided to bring about the unlocking of the bolt 30 when the movable support 20 is pivoted into its upper retracted position, as shown in FIG. 6.

According to the embodiment shown here, the base support 14 has a transverse strut 34 arranged near its back end, and the control surface 32 is formed by a portion of the bottom surface of the transverse strut 34.

Preferably, the bolt 30 has a lever 36 that is pivotably mounted to the movable support 20 about a transverse secondary pivot axis B2. This lever 36 is mounted directly over the sliding body 24 and is substantially aligned with the longitudinal axis A1.

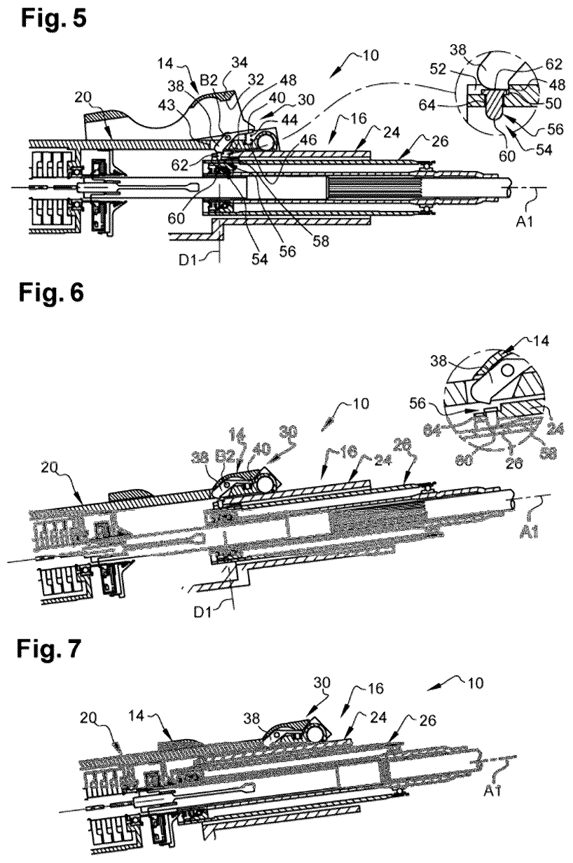

The lever 36 comprises a locking arm 38 provided to hold sliding body 24 in an extended position, as shown in FIGS. 4 and 5, and an actuating arm 40 provided to abut control surface 32 in the locked position, as shown in FIGS. 6 and 7. The lever 36 is pivotably mounted about the transverse secondary axis B2 between two bearings 42, which are formed integrally with the upper wall of the movable support 20. The locking arm 38 extends through a window 43 provided in the wall of base support 14.

The bolt 30 comprises an elastic return element 44 that biases the lever 36, in particular the locking arm 38, to its locked position. The elastic return element 44 is formed from a coil compression spring inserted between the inner side of the actuating arm 40 and a support surface 46 arranged on the upper wall of the movable support 20.

Advantageously, the locking arm 38 is provided with a blocking surface 48 adapted to cooperate with a holding surface 50 arranged oppositely on the sliding body 24 when the bolt 30 is in the locked state in order to hold the sliding body 24 in an extended position. For this purpose, the sliding body 24 has a notch 52 in its axial outer surface opposite the bolt 30, in which the holding surface 50 is formed. The notch 52 here is in the form of a longitudinal groove that is open at its front end and whose rear edge forms the holding surface 50.

It should be noted that the locking arm 38 extends between its locked angular position and its unlocked angular position, generally in a direction inclined at an angle between 70 and 20 degrees with respect to the longitudinal direction A1.

According to a particularly advantageous embodiment, the steering element 16 is provided with an additional unlocking device 54, which is provided to control the unlocking of the bolt 30 when the upper tube 26 exceeds an axial intermediate position P3 between the front axial position P1 and the rear axial position P2 during an axial forward movement of the upper tube 26 due to a frontal impact.

According to the embodiment shown here, the additional unlocking device 54 comprises an unlocking finger 56 arranged in the sliding body 24 and is provided to cooperate with an unlocking ramp 58 arranged on the upper tube 24.

The unlocking finger 56 here is in the form of a pin or block that generally extends in a diametric direction D1 with respect to the axial outer wall of the upper tube 26. This unlocking finger 56 has a substantially hemispherical lower actuation surface 60, which is provided to slide on the unlocking ramp 58 as it moves in the longitudinal direction, and has an upper actuation surface 62, which here is in the form of a plate perpendicular to the diametric direction D1 and is provided to push the locking arm 38 from its locked position to its unlocked position by moving upward in the diametric direction D1.

The unlocking finger 56 is received here in a receptacle 64 which is arranged in the bottom of the notch 52.

In the following, the operation of the invention will be described in more detail with reference to FIGS. 5-10, which show the steering column 10 in multiple positions associated with different operating situations.

In FIG. 5, the steering member 16 is shown in manual mode, wherein the steering column is fully extended to allow the driver to steer the vehicle 12 with the steering wheel 18. In this extended state, the sliding body 24 here occupies its extended axial position Pd. The bolt 30 is in the locked state, thereby preventing the sliding body 24 from exceeding the axial position forward, as the blocking surface 48 of the locking arm 38 opposes the holding surface 50 of the sliding body 24.

Here, the upper tube 26 may slide freely longitudinally between its axial intermediate position P3, which may cause unlocking, and its rear axial position P2 such that the driver may adjust the axial position of the steering wheel or the depth.

In FIG. 6, when changing from an extended configuration to a retracted configuration in order to transition to autonomous driving mode, the steering organ 16 is shown in a transition state, wherein the bolt 30 in an unlocked state. The movable support 20 is pivoted upwards until it brings about unlocking by relative abutment between the control surface 32 of the base support 14 and the actuating arm 40.

From this transition state, the sliding body 24 can slide freely axially forward and into its retracted position Pe, as the bolt 30 can no longer hold it.

FIG. 7 shows the steering member 16 in a retracted state, wherein the sliding body 24 and the upper tube 26 having slid forward from the position shown in FIG. 6. The bolt 30 is still in its unlocked state.

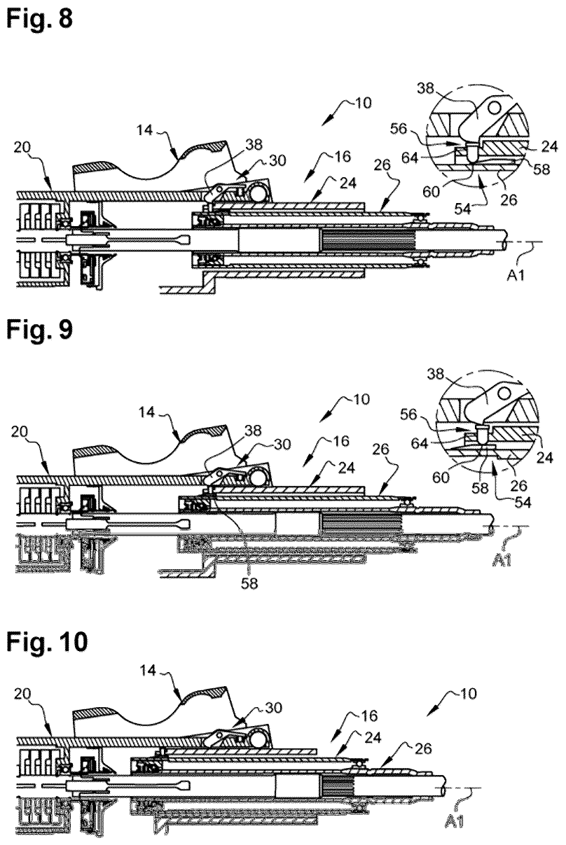

FIG. 8 shows the steering member 16 in a first transition state in a frontal impact, starting from the extended position of FIG. 5. While the sliding body 24 occupies its extended position Pd, a frontal impact has caused the upper tube 26 to start moving forwards longitudinally. During this longitudinal movement, when the upper tube 26 reaches its intermediate axial position P3, the unlocking ramp 58 comes into contact with the unlocking finger 56, thereby actuating the locking arm 38 in the unlocking direction and gradually transitioning the bolt 30 to its unlocked state.

Under the effect of the frontal impact, the upper tube 26 continues to move forward as shown in FIG. 9, and the lever 36 fully pivots to its unlocked position.

Once the bolt 30 reaches its unlocked state, it releases the sliding body 24 as the blocking surface 48 is offset upward with respect to the holding surface 50. Thus, the sliding body 24 can move forward in the longitudinal direction, as shown in FIG. 10, in order to assume a retracted position Pe which, in the event of an accident, ensures the protection of the driver by preventing hard contact with the steering member 16 and the steering wheel 18.

1. A steering column comprising (i) a base support which is configured to be fixedly mounted with respect to a vehicle chassis, (ii) a steering member, which is configured to be connected to a steering wheel, and (iii) actuators, wherein:
the steering column is configured to equip a vehicle that is operable in (i) a manual mode in which steering is controlled by a driver using the steering member, and (ii) an autonomous driving mode in which the steering is controlled by an electronic control unit,
the steering member extends along a longitudinal main axis and comprises:
a movable support pivotably mounted with respect to the base support about a transverse main pivot axis between a lower position and an upper retracted position adapted to the autonomous driving mode,
a sliding body which is mounted slidingly in the movable support between an extended axial position adapted to allow steering control by a driver in the manual mode and a retracted axial position adapted to the autonomous driving mode,
an upper tube which is mounted slidingly in the sliding body between a front axial position and a rear axial position to allow a depth adjustment of the position of the steering member in the manual mode,
the actuators are configured to control the movement of the various components of the steering member between their different positions,
the movable support comprises a bolt with (i) a locked state in which the bolt holds the sliding body axially in an extended position, and (ii) an unlocked state in which said bolt releases the sliding body, and
the base support has a control surface which is configured to bring about the unlocking of the bolt when the movable support is pivoted into its upper retracted position.

2. The steering column according to claim 1, wherein the bolt comprises a lever which is mounted pivotably on the movable support about a transverse secondary pivot axis, and wherein the lever comprises a locking arm which is configured to hold the sliding body in an extended position, and an actuating arm which is configured to rest against the control surface in the locked position.

3. The steering column according to claim 1, wherein the lever is mounted on a wall of the base support having a window, and wherein the locking arm extends through the window.

4. The steering column according to claim 2, wherein the bolt comprises an elastic return element that is configured to bias the lever to its locked position.

5. The steering column according to claim 2, wherein the lever comprises a locking arm that includes a blocking surface configured to cooperate with a holding surface arranged oppositely on the sliding body when the bolt is in the locked state in order to hold the sliding body in an extended position.

6. The steering column according to claim 1, wherein the sliding body comprises a notch in which the holding surface is formed.

7. The steering column according to claim 1, wherein the steering member includes an additional unlocking device, which is configured to control the unlocking of the bolt when the upper tube exceeds an axial intermediate position between the front axial position and the rear axial position during an axial forward movement towards the upper tube due to a frontal impact.

8. The steering column according to claim 1, wherein the additional unlocking device comprises an unlocking finger arranged in the sliding body and is configured to cooperate with an unlocking ramp arranged on the upper tube.

9. The steering column according to claim 8, wherein:
the sliding body comprises a notch in which the holding surface is formed, and
the unlocking finger is arranged in a receptacle located in the notch.
